(19) United States
(12) Patent Application Publication
(10) Pub. No.: US 2005/0090364 A1
(43) Pub. Date: Apr. 28, 2005

(54) Gearbox for power-driven tool

(75) Inventors: Lih-Tu Lee, Hsinchu City (TW); Hsi-Jen Jen, Hsinchu City (TW)

Correspondence Address: BIRCH STEWART KOLASCH & BIRCH, PO BOX 747, FALLS CHURCH, VA, 22040-0747, US

(73) Assignee: YIN KING INDUSTRIAL CO., LTD.

(21) Appl. No.: 10/962,432

(22) Filed: Oct. 13, 2004

(30) Foreign Application Priority Data
Oct. 28, 2003 (TW) 092219078

(51) Int. Cl. F16H 57/08

(52) U.S. Cl. 475/331

(57) ABSTRACT

A gearbox for a power-driven tool includes a skip-block mechanism and a reduction mechanism connecting to the skip-block mechanism. The reduction mechanism includes a skip-block ring, an inner gear, and a plurality of gears. The inner gear connects to one side of the skip-block ring away from the skip-block mechanism. The gears engage with the inner gear so that, when the skip-block mechanism is under force, the gears rotate inside the inner gear, and the skip-block ring and the skip-block mechanism engage with each other, reducing abrasion, and the skip-block mechanism is able to protect the gears.

### BACKGROUND OF THE INVENTION

1. Field of the Invention

The invention relates to a gearbox for a power-driven tool, and more particularly to a gearbox used in an electric drill.

2. Description of the Related Art

Portable electrical tools, such as electric drills, power-driven hammers or power-driven screwdrivers are very popular for both professionals and DIY (Do It Yourself) types. For example, electric drills are very useful tool for drilling woods, metals, bricks, stones, glass, or ceramics. By changing the fittings such as brushes, sand wheels, screwdrivers or nut wrenches front-mounted on the drills, the drills can be used to polish surfaces, drive or remove screws, or tighten or loosen nuts.

The conventional power-driven tool always has a gearbox to provide convenience to portability and operation. FIG. 3 and FIG. 4 illustrate a conventional gearbox used for a power-driven tool. The gearbox includes a base 10, a wheel 30, and a plurality of gears 50 functioning as a reduction mechanism. The base 10 is an annular hollow frame whose inner wall integrally forms a plurality of inner gear 101. An integrally-formed ragged skip-block face 102 is formed at one end of the base 10 as a skip-block ring. The wheel 30 is for insertion and engagement of the gears 50. With the engagement of the gears 50 and the inner gear 101, the wheel 30 is driven to rotate.

The inner gear 101 must have relatively high precision to precisely engage with the gears 50. The skip-block face 102 must be wear-resistant to reduce the rotation speed of the motor and increase torque output without wearing out too rapidly over time. The wear-resistance and service-life of the skip-block face 102 can be increased by powder metallurgy that sinters alloy steel powders, and then effects hardening by high-period wave thermal treatment.

However, since the base 10 integrally forms the inner gear 101 and the skip-block face 102, during hardening, the strength of the thermally treated skip-block face 102 is increased, but the precision of the inner gear 101 is reduced. Accordingly, the inner gear 101 and the gears 50 cannot precisely engage with one another during transmission, generating loud noise. If the reduction in precision is great, then an additional correcting step is required, increasing complexity and the cost of production.

If the skip-block face 102 is not subjected to a hardening process, then the wear-resistance of the skip-block face 102 is not high enough to withstand abrasion during operation. Therefore, the skip-block face 102 will rapidly wear out and the base 10 will need to be replaced. However, before the base 10 is replaced, the gears 50 may be damaged due to torque overload.

For some power-driven tools that need low torque, the inner gear is not necessarily formed of metal. Instead, the inner gear may be formed of inexpensive plastics by injection molding. However, the skip-block face requires considerable high hardness that cannot be achieved by plastics and injection molding. In other words, in such a case, the elements cannot be optimized due to the compromise made in the choice of materials for the inner gear and the skip-block face.

U.S. Pat. No. 5,277,527, and TW Patents No. 334869 and 337736 disclose gearboxes for power-driven tools. The U.S. Pat. No. 5,277,527 mounts a driving motor inside a gun-shaped casing and mounts the gearbox on one side of the driving motor. The rotational power of the driving motor outputs through the gearbox and the output torque is adjusted via a torque-adjusting mechanism. TW Patent No. 334869 discloses a electrical drill shaft locking device consisting of a bracket, a gear base, a column, a planetary transmission gear, a plurality of movable pins, a plurality of small gears, and a motor. The gear base is mounted on the bracket. The gear base has a plurality of teeth on its inner wall. When the motor rotates, the planetary wheel, the column and the central shafts of the bracket rotate simultaneously. When the motor stops rotating, the pins are trapped between the central shaft and an inner flange of the bracket for manual operation. TW Patent No. 337736 discloses a swing-hamming switch device of an electrical drill including a driving means having a rotating element for output of rotating power and a rotatable sun gear. The sun gear is equivalent to the above gear base. An annular frictional face is formed on one end of the sun gear in its axial direction. The frictional face has a plurality of protuberances equally distributed along its circumference for directly mounting the electric drill and for providing hamming function.

All of the above-disclosed gear bases have integrally-formed inner teeth and skip-block face, which fail to reach a good balance between high precision and hardness, and suffer increased production costs and non-optimization of elements.

The prior art does not address the feature requirements of both the inner teeth and the skip-block face of the gear base. The prior art lacks for optimization in aspects such as precision, hardness, and cost, resulting in noisy, heavy, and high-cost gearboxes. Therefore, there is a need of an improved gearbox for a power-driven tool that overcomes the prior problems.

### SUMMARY OF THE INVENTION

It is therefore an object of the invention to provide a gearbox for a power-driven tool that reduces abrasion.

It is another object of the invention to provide a gearbox for a power-driven tool that protects gear elements therein.

It is another object of the invention to provide a gearbox for a power-driven tool that generates less noise.

It is another object of the invention to provide a gearbox for a power-driven tool with reduced cost.

It is another object of the invention to provide a lightweight gearbox for a power-driven tool.

It is another object of the invention to provide a gearbox for a power-driven tool that increases the service-life of its skip-block face.

In order to achieve the above and other objectives, the gearbox for a power-driven tool of the invention includes a skip-block mechanism and a reduction mechanism connecting to the skip-block mechanism. The gearbox is characterized in that the reduction mechanism includes a skip-block ring connecting to the skip-block mechanism, an inner gear connecting to one side of the skip-block mechanism away from the skip-block ring, and a plurality of gears engaging with the inner gear so that, when the reduction mechanism is under force, the gears rotate in the inner gear, and the skip-block ring and the skip-block mechanism engage against each other to reduce the abrasion of reduction mechanism, and the gears are protected by the skip-block mechanism.

Since the skip-block ring and the inner gear are formed separately, they can be made of different materials, depending on the applications thereof. The skip-block ring may be formed of a high-hardness material and the inner gear is formed of a lightweight material. Thus, a more flexible design is provided to optimize elements.

The gearbox for the power-driven tool according to the invention has overcome the prior disadvantages and made the skip-block ring and the inner gear out of different materials. The production cost and weight of the gearbox are reduced while the high wear-resistant skip-block ring has an extended service lifetime. The precision of the teeth of the inner gear is not adversely affected in the subsequent hardening process of the skip-block ring, thereby reducing noise of the gearbox.

The gearbox according to the invention effectively reduces the rotation speed of the power-driven tool and increases torque output, while protecting the gears, reducing noise, and prolonging the service-lifetime of the skip-block ring.

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is an exploded view of a gearbox of a power-driven tool according to one preferred embodiment of the invention;

FIG. 2 is a perspective view of a gearbox of a power-driven tool according to one preferred embodiment of the invention;

FIG. 3 is an exploded view of a conventional gearbox; and

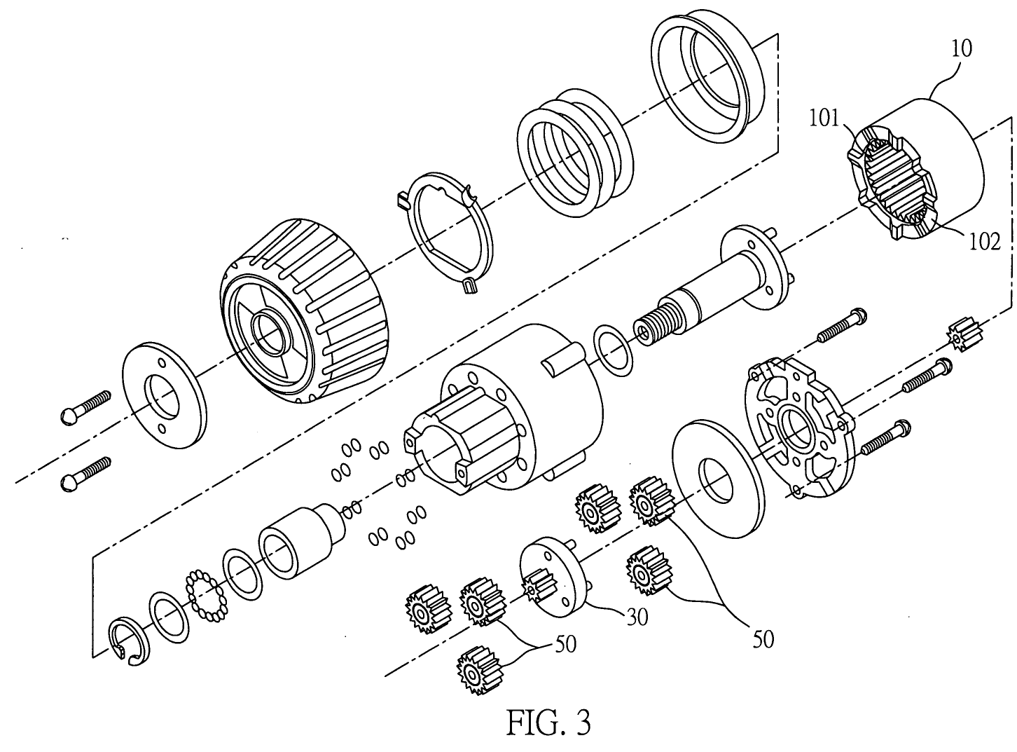

FIG. 4 is a perspective view of a conventional gearbox.

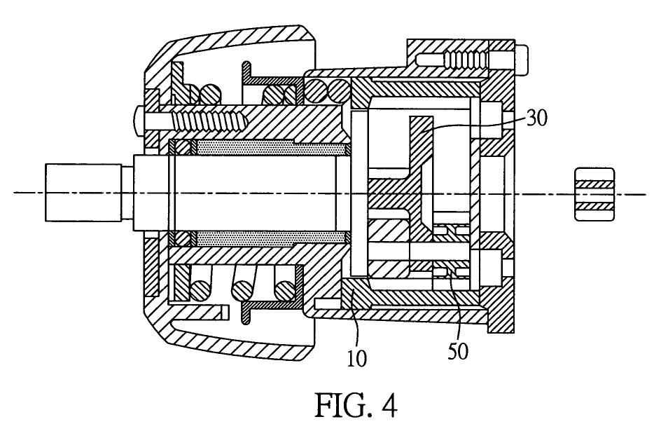

### DETAILED DESCRIPTION OF THE EMBODIMENTS

Wherever possible in the following description, like reference numerals will refer to like elements and parts unless otherwise illustrated.

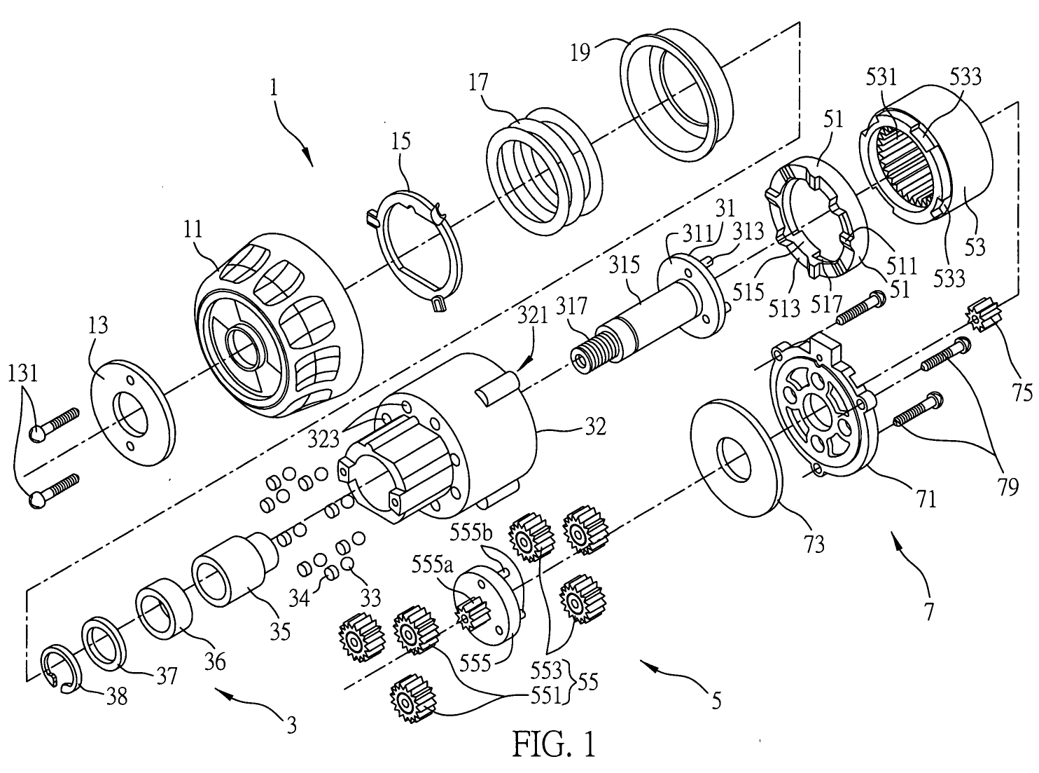

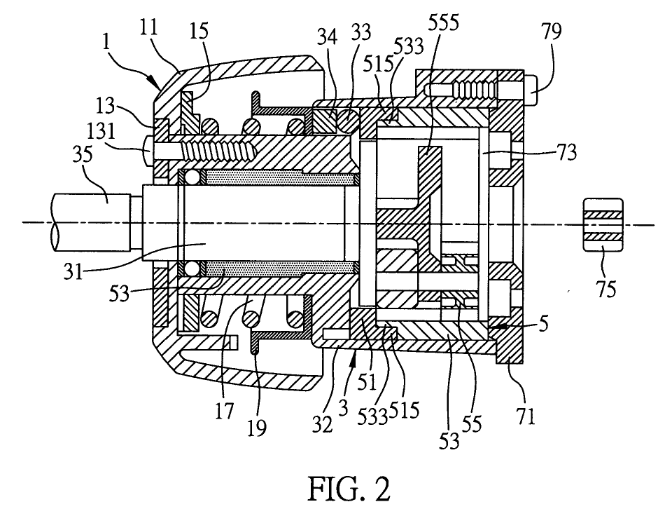

FIG. 1 and FIG. 2 illustrate a gearbox for a power-driven tool according to one embodiment of the invention. In FIG. 1, the gearbox for the power-driven tool includes a torque mechanism 1, a skip-block mechanism 3, a reduction mechanism 5 and a driving mechanism 7. It should be noted that the embodiment of the invention is illustrated by applying gearbox to a power-driven tool such as an electric drill. The gearbox at least includes the skip-block mechanism 3 and the reduction mechanism 5. For simplicity and not obscuring the features and structures of the embodiments of the present invention, only the parts of the gearbox directly relating to the invention are shown in the figures.

The torque mechanism 1 connects to the shaft of a power-driven tool (not shown) and is fixed by a fixture (not shown). The fixture serves to fix the power-driven tool. The power-driven tool and the fixture used for the power-driven tool are well known, and thus the description thereof is omitted herein.

The torque mechanism 1 optionally further includes a torque cap 11, a pressing plate 13, a gear shift wheel 15, a compression spring 17 and a restricting ring 19. The torque cap 11 is mounted on the fixture on one side of the fixture away from the power-driven tool and it is able to rotate left and right. The torque cap 11 is hollow for sequentially receiving the gear shift wheel 15, the compression spring 17, and the restricting ring 19. The pressing plate 13 is mounted at a front end of the torque cap 11 via a plurality of fastening elements 131. The fastening elements 131 can be, for example, screws. The restricting ring 19 restricts the compression spring 17 inside the torque cap 11. The compression spring 17, when compressed, generates a force to provide the elasticity required during rotation and reciprocation period. Although the torque mechanism 1 is specifically described in this embodiment, all other means that can function or structurally similar to the torque mechanism also fall within the spirit and scope of the invention.

The skip-block mechanism 3 is mounted on one side of the torque mechanism away from the power-driven tool. The skip-block mechanism 3 can be optionally further provided with a transmission wheel 31, a casing 32, a plurality of first positioning elements 33, a plurality of second positioning elements 34, an axle bush 35, an output shaft 36, a first piece 37, and a retainer 38.

The transmission wheel 31 connects to the reduction mechanism 5. The transmission wheel 31 includes a wheel body 311 connected to the reduction mechanism 5, a plurality of studs 313 formed on one side of the wheel body 311 away from the torque mechanism 1, a shaft body 315 formed on one side of the wheel body 311 away from the studs 313, and a threaded portion 317 formed on one side of the shaft body 315 away from the wheel body 311. The casing 32 has a first accommodating part 321 and a plurality of second accommodating parts 323. The first accommodating part 321 is located inside the casing 32 for receiving the transmission wheel 31. The plurality of second accommodating parts 323 are formed along the approximately stepped periphery of the casing 32. The first accommodating parts 321 and the second accommodating parts 323 are, for example, through holes.

The first positioning elements 33 can be, for example, balls. The second positioning elements can be, for example, rollers. The first positioning elements 33 and the second positioning elements 34 can be accommodated into the second accommodating parts 323 in a manner such that the first and second positioning elements 33, 34 are limited to axial movement only. The axle bush 35 is coaxially mounted on the shaft body 315 of the transmission wheel 31. The output shaft 36 is optionally mounted to the threaded portion 317 of the transmission wheel 31. The first piece 37 can be, for example, a pad plate. The retainer 38 can be, for example, a C-shaped ring. Of course, the first and second positioning elements 33, 34 are not limited to the above, and can be any equivalent elements thereof.

The reduction mechanism 5 is mounted on one side of the skip-block mechanism 3 away from the torque mechanism 1, and has a skip-block ring 51 connected to the skip-block mechanism 3, an inner gear 53 connected to one side the skip-block ring 51 away from the skip-block mechanism 3, and a plurality of gears 55 engaging within the inner gear 53.

The skip-block ring 51 contacts with the transmission gear wheel 31 of the skip-block mechanism 3 and the casing 32, and abuts against the first positioning elements 33. The skip-block ring 51 has a plurality of protrusions 511, frictional faces 513 and first engaging portions 515. The protrusions 511 are formed on one side of the skip-block ring 51 where the skip-block mechanism 3 connects. The frictional faces 513 are interspaced with the protrusions 511. When in operation, the skip-block ring 51 is forced to rotate, the first positioning elements 33 are fixedly positioned at the respective frictional faces 513 between the protrusions 511. The first engaging portions 515 are formed on the skip-block ring 51 near a lower periphery of the inner gear 53. That is, the first engaging portions 515 are on the side of the skip-block ring 51 away from each protrusion 511 and frictional face 513 to engage the skip-block ring 51 with the inner gear 53. In this embodiment, the skip-block ring 51 near the lower periphery of the inner gear 53 can be optionally provided with a plurality of recesses 517 spaced apart from one anther by the first engaging portions 515.

The skip-block ring 51 and the inner gear 53 can be made of different materials. For example, the skip-block ring 51 can be subjected to a hardening process, physical metallurgy, chemical metallurgy, blanketing, or mechanical metallurgy so that the skip-block ring 51 has a wear-resistant outer surface, and a high-toughness, high fatigue-resistant inner surface. In other words, the skip-block ring 51 is subjected to a proper surface treatment to increase its wear resistance and service life. The inner gear 53 is formed of a proper material, depending on the torque requirement. For example, when the gearbox is used in a low-torque application, the inner gear 53 is formed of plastics with added fibers to reduce the weight and lower the production cost. The skip-block ring 51 can be also formed of other resistant materials.

The skip-block ring 51 and the inner gear 53 can be separately made of different materials according to the intended application to reduce weight and production cost. In addition, the skip-block ring 51 can have high wear resistance so as to prolong its service life. Furthermore, the precision of the teeth of the inner gear 53 is not adversely affected by subsequent hardening processing of the skip-block ring, thereby reducing noises of the gearbox of the power-driven tool and solving the prior problems.

However, the skip-block ring 51 and the inner gear 53 can be formed of the same materials, but only the skip-block ring 51 needs to be subjected to surface treatment to increase its wear resistance. The inner gear 53 need not be subjected to the surface treatment to maintain the teeth precision. Therefore, the gearbox has good design flexibility and allows optimization of the components.

The inner gear 53 is, for example, a rotatable sun gear, and has a plurality of inner teeth 531 and a plurality of second engaging portions 533. The inner teeth 531 are mounted around the inner wall of the inner gear 53 to engage with the gears 55. The second engaging portions 533 respectively engage with the first engaging portions 515 of the skip-block ring 51, so that the inner gear 53 drives the skip-block ring 51 to rotate. The first engaging portions 515 and the second engaging portions 533 respectively correspond to and engage with one another. When the inner gear 53 rotates, the inner gear 53 drives the skip-block ring 51 to rotate. The first engaging portions 515 and the second engaging portions 533 correspond to and engage with one another. The structure for engagement is not limited to the first engaging portions 515 and the second engaging portions 533 described above, as long as it allows the inner gear 53 and the skip-block ring 51 to engage and allows the inner gear 53 to drive the skip-block ring 51.

The gears 55 can be, for example, planetary gears that rotate around the center of the inner gear 53 with a high reduction ratio. In this embodiment, the gears 55 are divided into two subgroups of planetary gears 551 and 553 spaced apart by a planetary gear wheel 555. The studs 313 of the transmission wheel 31 insert through the subgroup of planetary gears 551 to drive the transmission wheel 31. The planetary gear wheel 555 has planetary engaging parts 555a and insertion parts 555b. The planetary engaging parts 555a engage with the subgroup of planetary gears 551. The insertion parts 555b receive the subgroup of planetary gears 553 so that the teeth of the subgroup of planetary gears 553 engage with one another. Meanwhile, the subgroups of planetary gears 551 and 553 engage with the inner teeth 531 in the inner periphery of the inner gear 53. The subgroup of planetary gears 551 can be, for example, conventionally used transmission gears. The subgroup of planetary gears 553 can be, for example, plastic gears. However, the two subgroups of planetary gears are not limited to the above.

In this embodiment, three gears 55 form one subgroup of planetary gears. The subgroups of planetary gears 551, 553 are positioned one at the front and one at the back of the planetary gear wheel 555. Noted that the amount, combination, and types of gears 55 are not limited to the above.

The driving mechanism 7 is mounted on one side of the reduction mechanism 5 away from the skip-block mechanism 3. The driving mechanism 7 can includes a plate 71, a second piece 73 and a driving element 75. The plate 71 can be, for example, a motor plate mounted to the casing 32 via a plurality of fastening elements 79 in a manner that one side of the plate 71 joints the reduction mechanism 5 and the other side of the plate 71 connects to a driving source (not shown) such as a motor via the driving element 75. The second piece 73 can be, for example, a motor pad mounted to the plate 71. The driving element 75 inserts through the plate 71 and the second piece 73, and drives the gears 55 of the reduction mechanism 5. The driving element 75 can be, for example, a motor gear connecting to the driving source to drive the gears 55 in the reduction mechanism 5. The operating relationship between the driving element 75, the driving source and the reduction mechanism 5 are well known in the art, and thus the descriptions thereof are omitted herein.

In FIG. 2, when the driving source is actuated, the driving element 75 is driven to allow the gears 55 of the reduction mechanism 5 to position inside the inner gear 53 and rotate along the inner periphery of the inner gear 53. The planetary wheel 555 rotates in accompaniment with the gears 55 inside the inner gear 53. All of the transmission gears 55 cooperates with the inner gear 53. The transmission gear wheel 31 is driven by one of the subgroups of planetary gears, which is the subgroup of planetary gears 551 in this embodiment. The first positioning elements 33 may roll, slide, and skip on the skip-block ring 51.

When the inner gear 53 rotates, the first positioning elements 33 abrade the frictional faces 513 and pass over the protrusions 511 to generate a resistance force against the rotation of the inner gear 53.

Under normal operation, the inner gear 53 of the reduction mechanism 5 is abutted against the skip-block ring 51 by the force exerted from the first positioning elements 33 and stays engaged. On the contrary, when the output shaft 36 is overloaded, that is the load-exerted force is larger than the force of the compression spring 17 applying against the restricting ring 19 and in turns against the second positioning elements 34, the skip-block ring 51 starts to rotate and drive the inner gear 53 and the first positioning elements 33 skips on the skip-block ring 51, thereby damage that could be caused to the gears 55 of the reduction mechanism 5 due to gears overloading can be avoided. Furthermore, when the load (torque) is too large to tightly contact the gears 55 and the inner teeth 531 of the inner gear 53, the first positioning elements skip on the skip-block ring 51 to cause the gears to run idle, thereby preventing the gears and the driving source from being overloaded. Breakdown of gears and overheating of the driving source are avoided.

Since the power is output from the driving source via the gears 55, the inner gears 53, the skip-block ring 51 and the skip-block mechanism 3, the rotational speed is reduced to prevent overloading of the gears 55. Thereby, not only the torque output is increased, but also the gears 55 can operate under normal conditions without generating excess noise.

The loading torque can be adjusted by tuning the torque cap 11. When the gear shift wheel 15 abuts against the lowest position on an inner slant surface of the torque cap 11, the elongation of the compression spring 17 is at its maximum, that is, the tension of the compression spring 17 is the smallest. Therefore, the force abutting the first positioning elements 33 against the skip-block ring 51 is smallest and the torque loaded on the output shaft 35 is also smallest. Conversely, when the gear shift wheel 15 abuts against the highest position on the inner slant surface of the torque cap 11, i.e. the elongation of the compression spring 17 is smallest, the force abutting the first positioning elements 33 against the skip-block ring 51 is largest and the torque loaded on the output shaft 35 is largest. Thereby, the torque is adjusted by tuning the torque cap 11.

In the embodiments of the present invention, the skip-block ring 51 and the inner gear 53 are separated produced so that the rotation between the gears 55 in the inner gear 53 reduces the rotation speed of the driving source and increases the output torque. The skip-block ring 51 allows rolling, sliding and skipping of the first positioning elements 33 thereon. Furthermore, the skip-block ring 51 and the inner gear 53 may be formed of different materials according to the intended application. The precision and wear-resistance may be thereby increased. The invention is characterized in the separate production of the skip-block ring 51 and the inner gear 53 rather than the materials and processing used to make the skip-block ring 51 and the inner gear 53.

When the reduction mechanism 5 is applied with the pushing force by the driving mechanism 7, the gears 55 rotate around the inner gear 53, and the skip-block ring 51 engages the skip-block mechanism 3. With jumping of the first positioning elements 33 and the second positioning elements 34, the gears 55 are protected from overloading. The reduction mechanism 5 reduces the rotation speed of the power-driven tool and increases the output torque, with the skip-block mechanism 3 protecting the gears 55.

When either the skip-block ring 51 or the inner gear 53 is broken, only the faulty one needs to be replaced. Compared to the prior art where the whole gear set including the skip-block mechanism and the inner teeth must be replaced, the gearbox of the present invention only needs to replace the damaged element instead of the whole structure. Therefore, maintenance cost can be reduced. Furthermore, the processing of the skip-block ring 51 to increase its wear-resistance and the selection of the material used to make the skip-block ring 51 do not adversely affect the precision of the inner gear 53.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

1. A gearbox for a power-driven tool, comprising a skip-block mechanism and a reduction mechanism connecting to the skip-block mechanism, the gearbox being characterized in that the reduction mechanism includes a skip-block ring, an inner gear, and a plurality of gears, the skip-block ring connecting to the skip-block mechanism, the inner gear connecting to one side of the skip-block ring away from the skip-block mechanism, the plurality of gears engaging with the inner gear so that, when the skip-block mechanism is under force, the plurality of gears rotate in the inner gear, and the skip-block ring and the skip-block mechanism engage with each other to reduce abrasion, thereby the skip-block mechanism is able to protect the gears.

2. The gearbox of claim 1, further comprising a torque mechanism.

3. The gearbox of claim 2, wherein the torque mechanism includes a torque cap, a pressing plate, a gear shift wheel, a compression spring, and a restricting ring.

4. The gearbox of claim 1, wherein the skip-block mechanism has a transmission wheel connecting to the reduction mechanism.

5. The gearbox of claim 4, wherein the transmission wheel has a wheel body, a plurality of studs, a shaft body, and a threaded portion.

6. The gearbox of claim 1, wherein the skip-block mechanism has a casing.

7. The gearbox of claim 6, wherein the casing has a first accommodating part and a plurality of second accommodating parts.

8. The gearbox of claim 7, wherein the first accommodating part is a through hole.

9. The gearbox of claim 7, wherein the plurality of second accommodating parts are through holes.

10. The gearbox of claim 1, wherein the skip-block mechanism has a plurality of positioning elements.

11. The gearbox of claim 10, wherein the positioning elements include first positioning elements and second positioning elements.

12. The gearbox of claim 11, wherein the first positioning elements are balls.

13. The gearbox of claim 11, wherein the second positioning elements are rollers.

14. The gearbox of claim 1, wherein the skip-block mechanism has an axle bush, an output shaft, a first piece and a retainer.

15. The gearbox of claim 1, wherein the skip-block ring has a plurality of protrusions, frictional faces, and first engaging portions.

16. The gearbox of claim 1, wherein the skip-block ring and the inner gear are formed of different materials.

17. The gearbox of claim 1, wherein the inner gear has a plurality of inner teeth formed on the inner wall thereof and a plurality of second engaging portions.

18. The gearbox of claim 1, wherein the inner gear is a rotatory sun gear.

19. The gearbox of claim 1, wherein the gears are planetary gears rotating around the center of the inner gear.

20. The gearbox of claim 1, wherein the gears include two subgroups of planetary gears, which are spaced apart from each other by a planetary transmission wheel.

21. The gearbox of claim 1, further comprising a driving mechanism.

22. The gearbox of claim 21, wherein the driving mechanism is mounted on one side of the reduction mechanism away from the skip-block mechanism, and is optionally provided with a plate, a second piece, and a driving element.

23. The gearbox of claim 22, wherein the plate is a motor plate.

24. The gearbox of claim 22, wherein the second piece is a motor pad mounted to the plate.

25. The gearbox of claim 22, wherein the driving element is a motor gear used to drive the gears in the reduction mechanism.
